(19) United States
(12) Patent Application Publication
(10) Pub. No.: US 2022/0293010 A1
(43) Pub. Date: Sep. 15, 2022

(54) INFORMATION PROCESSING APPARATUS AND INFORMATION PROCESSING METHOD

(71) Applicant: SONY GROUP CORPORATION, TOKYO (JP)

(72) Inventors: HIDEAKI WATANABE, TOKYO (JP); NORIKO TOTSUKA, KANAGAWA (JP); CHIE KAMADA, TOKYO (JP); YUKI TAKEDA, TOKYO (JP); KAZUYA TATEISHI, TOKYO (JP); YUICHIRO KOYAMA, TOKYO (JP); EMIRU TSUNOO, TOKYO (JP); AKIRA TAKAHASHI, TOKYO (JP); AKIRA FUKUI, TOKYO (JP); KAN KURODA, TOKYO (JP); HIROAKI OGAWA, TOKYO (JP); YOSHINORI MAEDA, TOKYO (JP); JUNYA SUZUKI, TOKYO (JP)

(21) Appl. No.: 17/309,973

(22) PCT Filed: Nov. 11, 2019
(86) PCT No.: PCT/JP2019/044041

§ 371 Date: Jul. 7, 2021

(30) Foreign Application Priority Data
Jan. 15, 2019 (JP) 2019-004414

(51) Int. Cl. G09B 21/00; G05B 15/02

(52) U.S. Cl. CPC G09B 21/008; G05B 15/02

(57) ABSTRACT

An information processing apparatus includes a control unit that generate second setting information related to a first setting item and a second setting item different from the first setting item of a second object used by the user based on first setting information related to the first setting item of a first object acquired when the user uses the first object.

### FIELD

The present disclosure relates to an information processing apparatus and an information processing method.

### BACKGROUND

A person may make settings according to his/her ability when using software or hardware. For example, a visually impaired user makes settings such as increasing a character size and increasing brightness in order to make characters easier to see. In recent years, the number of objects that permits settings according to user's ability, such as terminal devices such as smartphones, wearable terminals, and home appliances (household electric appliances), and applications executed in the terminal devices, is increasing. In view of this, in recent years, techniques for supporting settings according to user's ability have been developed.

For example, Patent Literature 1 below discloses a technique for setting accessibility of an information screen of an information processing apparatus for each user.

### CITATION LIST

### Patent Literature

Patent Literature 1: JP 2016-134694 A

### SUMMARY

### Technical Problem

However, in the technique described in Patent Literature 1, at least the accessibility is set by a user. Considering that accessibility setting items can be diverse, it would be a great burden to let a user set all of the setting items.

In view of this, the present disclosure provides a mechanism capable of lessening burden for making settings according to user's ability.

### Solution to Problem

According to the present disclosure, an information processing apparatus is provided that includes: a control unit that generate second setting information related to a first setting item and a second setting item different from the first setting item of a second object used by the user based on first setting information related to the first setting item of a first object acquired when the user uses the first object.

Moreover, according to the present disclosure, an information processing method is provided that includes: causing a processor to generate second setting information related to a first setting item and a second setting item different from the first setting item of a second object used by the user based on first setting information related to the first setting item of a first object acquired when the user uses the first object.

### BRIEF DESCRIPTION OF DRAWINGS

FIG. 1 is a block diagram illustrating an example of a configuration of a system according to an embodiment of the present disclosure.

FIG. 2 is a graph for explaining an example of time-series changes in disability severity information according to the present embodiment.

FIG. 3 is a graph for explaining an example of disability severity information estimation processing according to the present embodiment.

FIG. 4 is a flowchart illustrating an example of a flow of accessibility setting processing executed by the information processing apparatus according to the present embodiment.

FIG. 5 is a block diagram illustrating an example of a configuration of a system according to a second modification.

FIG. 6 is a diagram for explaining an outline of a neural network.

FIG. 7 is a diagram for explaining an application example of a neural network in an information processing apparatus according to a third modification.

FIG. 8 is a block diagram illustrating an example of a hardware configuration of an information processing apparatus according to the present embodiment.

### DESCRIPTION OF EMBODIMENTS

A preferred embodiment of the present disclosure will be described in detail below with reference to the accompanying drawings. In the present specification and the drawings, constituent elements having substantially identical functional configurations are given identical reference signs, and repeated description thereof will be omitted.

Explanations will be given in the following order.

1. Example of configuration

1.1. Example of system configuration

1.2. Example of configuration of information processing apparatus

2. Flow of processing

3. Use case

4. Modifications

4.1. First modification

4.2. Second modification

4.3. Third modification

4.4. Fourth modification

5. Example of hardware configuration

6. Summary

1. Example of Configuration>>

<1.1. Example of System Configuration>

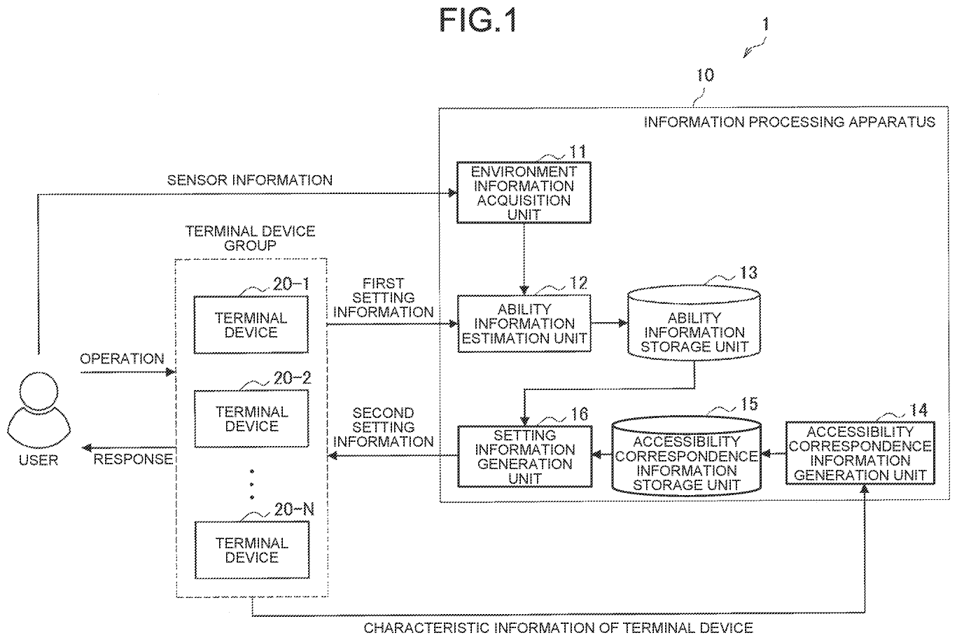

FIG. 1 is a block diagram illustrating an example of a configuration of a system according to an embodiment of the present disclosure. As illustrated in FIG. 1, a system 1 according to the present embodiment includes an information processing apparatus 10 and a terminal device group including a plurality of terminal devices 20 (20-1 to 20-N). Hereinafter, the terminal devices 20-1 to 20-N are also collectively referred to as the terminal device 20 in a case where they need not be distinguished from each other.

(1) Terminal Device 20

The terminal device 20 is an example of an object used by a user and for which settings according to the ability of the user are made. Examples of the terminal device 20 include a television set (that is, a television receiver), a smartphone, a video camera, and a microwave oven. The terminal device 20 outputs a response when operated by the user.

The terminal device 20 makes settings of the terminal device 20 based on first setting information input by the user. The terminal device 20 outputs (for example, transmits) the first setting information input by the user to the information processing apparatus 10. When second setting information is input (for example, received) from the information processing apparatus 10, the terminal device 20 makes settings of the terminal device 20 based on the second setting information. Hereinafter, the terminal device 20 to which the first setting information is input by the user is also referred to as a first terminal device 20. Hereinafter, the terminal device 20 to which the second setting information is input by the information processing apparatus 10 on behalf of the user is also referred to as a second terminal device 20. The first terminal device 20 and the second terminal device 20 are also collectively referred to as a terminal device 20 in a case where they need not be distinguished from each other.

The first setting information is setting information related to accessibility to output of the first terminal device 20. The first setting information includes a setting value of one or more setting items. The terminal device 20 extracts the first setting information from an operation history related to accessibility settings in a user's operation history. As another example, the terminal device 20 may output the operation history to the information processing apparatus 10, and the information processing apparatus 10 may extract the first setting information.

The second setting information is setting information related to accessibility to output of the second terminal device 20. The second setting information includes a setting value of one or more setting items as in the case of the first setting information. The first setting information and the second setting information are also simply referred to as setting information in a case where they need not be distinguished from each other.

The setting information is set according to the user's ability in order to assist the user's ability deteriorated due to a disability, injury, illness, or the like. The user's ability is ability of the organs that make up the user's body. Specifically, the user's ability includes ability of a sensory system. The ability of the sensory system is, for example, a concept that includes ability of the five senses consisting of sight, hearing, touch, taste, and smell, as well as ability of other senses such as a sense of balance. Furthermore, the user's ability may also include ability of a motor system such as bones, joints, ligaments, and muscles. The ability of the motor system is, for example, a concept that includes muscle strength and a range of motion of joints. The user's ability may also include ability of brain functions such as cognitive ability, language ability, and speech ability.

For example, the setting information may include setting information regarding at least one of character size, zoom, contrast, character reading, and operation feedback sound as setting information regarding vision. For example, a character size is set according to the setting information regarding a character size. For example, screen zoom ON/OFF and a zoom rate are set according to setting information regarding zoom. For example, a contrast ratio is set by setting information regarding contrast. For example, ON/OFF of a character reading function and a reading speed are set by setting information regarding character reading. For example, ON/OFF of a function of feeding back operation sound upon receipt of an operation and a volume of the feedback sound are set by setting information related to operation feedback sound. Furthermore, the setting information related to vision may include any other setting information such as color or depth.

For example, the setting information includes setting information regarding at least one of sound volume, speech enhancement, visual notification, and subtitles as setting information regarding hearing. For example, a sound volume level is set by setting information regarding a sound volume. For example, ON/OFF of a speech enhancement function and a degree of speech enhancement are set by setting information regarding speech enhancement. For example, ON/OFF of notification using light emitting diode (LED) flash is set by setting information regarding visual notification. For example, ON/OFF of subtitles is set by setting information regarding subtitles. Furthermore, the setting information regarding hearing may include any other setting information such as ON/OFF of a frequency band or echo function.

(2) Information Processing Apparatus 10

The information processing apparatus 10 is an apparatus that generates second setting information based on acquired information and transmits the second setting information to the second terminal device 20 so that the second setting information is set in the second terminal device 20. The information processing apparatus 10 inputs the second setting information to the second terminal device 20 on behalf of the user, and realizes assistance of the user's ability deteriorated due to a disability or the like in the second terminal device 20.

Exchange of information between the information processing apparatus 10 and the terminal device 20 is realized by communication according to any wired or wireless communication standard. Examples of such a communication standard include a local area network (LAN), a wireless LAN, Wi-Fi (registered information), and Bluetooth (registered information). However, to transmit the second setting information, the information processing apparatus 10 may use means corresponding to operation means of the terminal device 20. For example, since a television set is typically remotely controlled by an infrared signal transmitted from a remote controller, the information processing apparatus 10 may transmit the second setting information to the television set by using an infrared signal. In a case where the terminal device 20 supports voice operation, the information processing apparatus 10 may transmit the second setting information to the terminal device 20 by emitting voice corresponding to the second setting information.

<1.2. Example of Configuration of Information Processing Apparatus>

An example of a configuration of the information processing apparatus 10 will be described with reference to FIG. 1. As illustrated in FIG. 1, the information processing apparatus 10 includes an environment information acquisition unit 11, an ability information estimation unit 12, an ability information storage unit 13, an accessibility correspondence information generation unit 14, an accessibility correspondence information storage unit 15, and a setting information generation unit 16.

Environment Information Acquisition Unit 11

The environment information acquisition unit 11 has a function of acquiring environment information indicating an environment in which the user uses the terminal device 20. The environment information acquisition unit 11 acquires environment information based on sensor information detected by a sensor device. The environment information acquisition unit 11 may include various sensor devices, such as an image sensor, a sound sensor, and an illuminance sensor, that detect information about an environment around the user. The environment information acquisition unit 11 outputs the acquired environment information to the ability information estimation unit 12.

As an example, the environment information acquisition unit 11 acquires environment information regarding vision, such as whether or not the terminal device 20 is located outdoors or indoors, whether it is daytime or nighttime, whether or not lighting equipment is lit, and whether or not a curtain is open. For example, environment information regarding vision is acquired based on a detection result of the terminal device 20 or an illuminance sensor or an image sensor provided around the terminal device 20.

As another example, the environment information acquisition unit 11 acquires environment information regarding hearing, such as a sound volume and a frequency band of environment sound. The environment information regarding hearing is acquired based on a detection result of the terminal device 20 or a sound sensor provided around the terminal device 20.

As another example, the environment information acquisition unit 11 acquires environment information regarding the user such as who is operating the terminal device 20 and in what use case (for example, whether or not the user is in a hurry) the terminal device 20 is operated. For example, the environment information regarding the user is acquired by image recognition of an image detected by the terminal device 20 or an image sensor provided around the terminal device 20 or voice recognition of voice detected by a microphone.

Ability Information Estimation Unit 12

The ability information estimation unit 12 has a function of estimating ability information indicating user's ability. The ability information estimation unit 12 outputs the estimated ability information to the ability information storage unit 13. The ability information estimation unit 12 identifies a user based on the environment information and estimates ability information for each user.

The ability information estimation unit 12 estimates the ability information of the user based on the first setting information of the first terminal device 20. As an example, the ability information estimation unit 12 estimates ability information regarding vision based on the setting information regarding vision. Specifically, the ability information estimation unit 12 estimates that a larger character size, ON of character reading, and a higher contrast ratio indicate a lower visual ability, and vice versa. As another example, the ability information estimation unit 12 estimates ability information regarding hearing based on the setting information regarding hearing. Specifically, the ability information estimation unit 12 estimates that a larger sound volume, ON of subtitles, and ON of speech enhancement indicate a lower auditory ability, and vice versa.

Further, the ability information estimation unit 12 may estimate the user's ability information based on environment information (corresponding to the first environment information) acquired when the user uses the first terminal device 20. As an example, the ability information estimation unit 12 estimates the ability information regarding vision based on indoor illuminance. Specifically, the ability information estimation unit 12 estimates that higher indoor illuminance indicates a lower visual ability and lower indoor illuminance indicates a higher visual ability. The lower the indoor illuminance, the harder it is to read characters output from the terminal device 20. In this regard, in a case where the same character size setting is used, it can be said that the visual ability is high when characters can be read even in a low indoor illuminance and the visual ability is low when characters cannot be read unless the indoor illuminance is high. As another example, the ability information estimation unit 12 estimates ability information regarding hearing based on a sound volume of environment sound (for example, noise). Specifically, the ability information estimation unit 12 estimates that a lower sound volume of environment sound indicates a lower auditory ability and a higher sound volume of environment sound indicates a higher auditory ability. The higher a sound volume of environment sound, the harder it is to hear sound output from the terminal device 20 (hereinafter, also referred to as target sound). In this regard, in a case where the same sound volume setting is used, it can be said that the hearing ability is high in a case where the target sound can be heard even if the sound volume of the environment sound is high and the hearing ability is low in a case where the target sound cannot be heard unless the sound volume of the environment sound is low. By thus taking environment information into consideration, it is possible to estimate accurate ability information excluding influence of the environment.

Further, the ability information estimation unit 12 may estimate the ability information of the user based on characteristic information indicating characteristics regarding accessibility of the first terminal device 20. The characteristic information includes information indicating device capability related to accessibility such as a display size and speaker performance. In addition, the characteristic information includes information indicative of characteristics of accessibility settings, such as the type of setting item, a settable range of a setting value of each setting item, and accessibility of information output corresponding to a setting value (for example, a setting value of a character size and an actually displayed character size). Even if the same setting information is used, a difference in characteristic information can lead to a difference in accessibility to information output from the terminal device 20. In this regard, by adding the characteristic information of the terminal device 20, it is possible to estimate accurate ability information excluding a difference in characteristics among the terminal devices 20.

The ability information is a value corresponding to a level of user's ability. The ability information can be estimated for each organ. For example, the ability information regarding vision may include values indicating visual acuity, a color discriminating ability, and the like. The ability information regarding hearing may include values indicating a hearing ability, an audible range, and the like.

In the following, as an example, it is assumed that the ability information is disability severity information indicating a severity of a disability. For example, the disability severity information is a continuous value or a discrete value, and a lower user's ability (that is, the heavier the disability) results in a higher value of the disability severity information, and a higher user's ability (that is, the lighter the disability) results in a lower value of the disability severity information. Disability severity information expressed as a discrete value is also referred to as a disability severity level. The disability severity information is estimated for a disability of each organ such as sight and hearing.

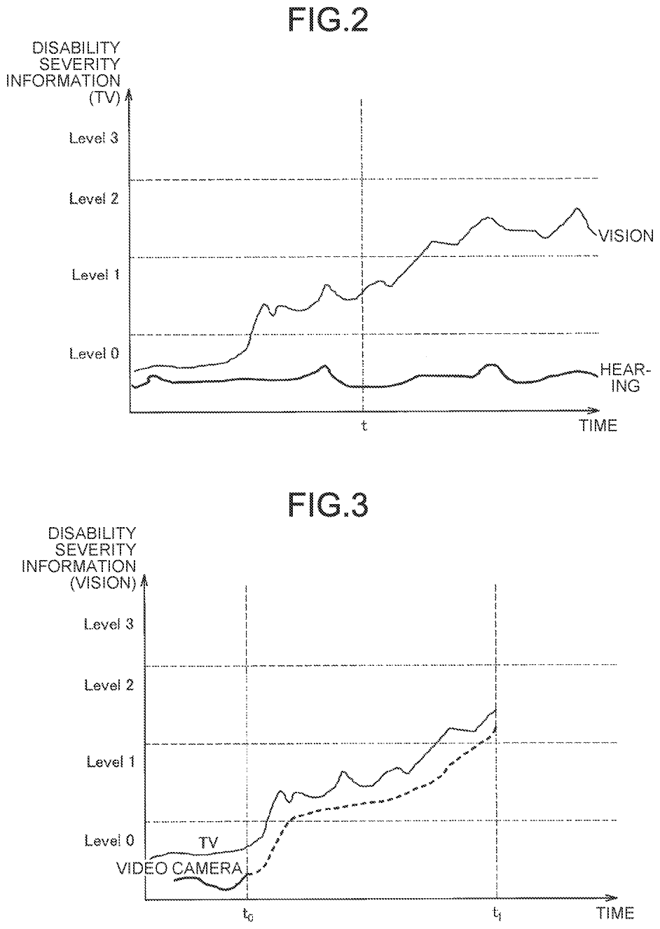

The disability severity information decreases with passage of time, aging, or progress of the disability or improves with recovery of the disability. Therefore, the ability information estimation unit 12 estimates the disability severity information at predetermined time intervals. The predetermined time intervals may be any time intervals such as several hours, one day, or several weeks. An example of time-series changes in disability severity information will be described below with reference to FIG. 2.

FIG. 2 is a graph for explaining an example of time-series changes in disability severity information according to the present embodiment. The vertical axis of this graph is severity of a disability estimated based on the first setting information of the television set, and the horizontal axis is time. As illustrated in this graph, severity of visual impairment increases with passage of time, and a severity level of visual impairment at a time t is 1. As illustrated in this graph, severity of hearing impairment remains constant while repeating up and down with passage of time, and a severity level of hearing impairment at the time t is 0.

The disability severity information may be estimated for each terminal device 20. This is because characteristics concerning accessibility may differ from one terminal device 20 to another. In this respect, by estimating the user's disability severity information for each terminal device 20, it is possible to more appropriately generate the second setting information described later.

The ability information estimation unit 12 may estimate the disability severity information regarding a terminal device 20 whose frequency of use is low based on the disability severity information regarding a terminal device 20 whose frequency of use is high. The frequency of use in the present specification is a concept that encompasses not only the number of times of use in a predetermined period but also an elapsed time from user's previous use. For example, high frequency of use means user's recent use, and low frequency of use means lack of user's recent use. The first setting information acquired for the terminal device 20 whose frequency of use is low may be first setting information acquired long time before, and the disability severity information estimated based on such old first setting information does not reflect time-series changes in the disability severity information. Therefore, the ability information estimation unit 12 estimates the user's disability severity information regarding the terminal device 20 whose frequency of use is low based on the first setting information regarding the terminal device 20 whose frequency of use is high. This makes it possible to estimate more accurate disability severity information reflecting time-series changes of the disability severity information even for the terminal device 20 whose frequency of use is low. This will be described below with reference to FIG. 3.

FIG. 3 is a graph for explaining an example of disability severity information estimation processing according to the present embodiment. The vertical axis of this graph is severity of visual impairment, and the horizontal axis of this graph is time. In this graph, time-series transition of the disability severity information regarding a television set and time-series transition of the disability severity information regarding a video camera are shown.

Until a time t₀, both of the television set and the video camera are in use. Therefore, in a period up to the time t₀, the ability information estimation unit 12 estimates the disability severity information regarding the television set based on the first setting information of the television set and estimates the disability severity information regarding the video camera based on the first setting information of the video camera. For example, the ability information estimation unit 12 estimates that a disability severity level regarding the television set is 1 and a disability severity level regarding the video camera is 1 at the time t₀.

During a period from the time t₀ to a time t₁, only the television set is used and the video camera is not used. Therefore, during the period from the time t₀ to the time t₁, the ability information estimation unit 12 estimates the disability severity information regarding the television set and the disability severity information regarding the video camera based on the first setting information of the television set. For example, the ability information estimation unit 12 calculates a correlation between the time-series transition of the disability severity information regarding the television set during the period up to the time t₀ and the time-series transition of the disability severity information regarding the video camera during the period up to the time t₀. Assuming that the correlation holds even during the period from the time t₀ to the time t₁, the ability information estimation unit 12 estimate the user's disability severity information regarding the video camera by reflecting the correlation in the user's disability severity information regarding the television set.

More specifically, during the period up to the time t₀, the severity of disability regarding the video camera is lower than the severity of disability regarding the television set and changes over time in a similar manner to the severity of disability regarding the television set. Therefore, the ability information estimation unit 12 estimate the severity of disability regarding the video camera by assuming that the severity of the disability regarding the video camera is lower than the severity of the disability regarding the television set and changes over time in a similar manner to the severity of the disability regarding the television set even during the period from the time t₀ to the time t₁. For example, at the time t₁, the ability information estimation unit 12 estimates that the disability severity level regarding the television set is 2 and estimates that the disability severity level regarding the video camera is 2.

Disability severity information of different organs may be estimated by a method similar to the method described with reference to FIG. 3. As an example, the ability information estimation unit 12 may estimate disability severity information regarding hearing based on the disability severity information regarding vision. Specifically, the ability information estimation unit 12 calculates a correlation between time-series transition of the disability severity information regarding vision and time-series transition of the disability severity information regarding hearing. Assuming that the correlation always holds, the ability information estimation unit 12 estimates the disability severity information regarding hearing by reflecting the correlation in the disability severity information regarding vision. This makes it possible to more accurately estimate the disability severity information regarding hearing for a user with visual impairment and hearing impairment in a case where the frequency of update of setting information regarding vision is high and the frequency of update of setting information regarding hearing is low.

Ability Information Storage Unit 13

The ability information storage unit 13 has a function of storing the disability severity information output from the ability information estimation unit 12. The ability information storage unit 13 outputs the stored disability severity information to the setting information generation unit 16.

Accessibility Correspondence Information Generation Unit 14

The accessibility correspondence information generation unit 14 has a function of generating accessibility correspondence information based on the characteristic information of each terminal device 20. The accessibility correspondence information generation unit 14 outputs the generated accessibility correspondence information to the accessibility correspondence information storage unit 15.

The accessibility correspondence information is information indicating, for each terminal device 20, setting items to be set and setting values for the respective setting items corresponding to the disability severity information. By referring to the characteristic information, the accessibility correspondence information generation unit 14 can generate appropriate accessibility correspondence information corresponding to characteristics concerning accessibility, which differs from one terminal device 20 to another. Table 1 below shows an example of accessibility correspondence information regarding vision. Table 2 below shows an example of accessibility correspondence information regarding hearing.

TABLE 1
Accessibility correspondence information regarding vision

| disability | terminal device | | | |
|---|---|---|---|---|
| severity | television | | video | |
| level | set | smartphone | camera | microwave |
| level 0 | none | none | none | N/A |
| | | | | (no setting |
| | | | | item) |
| level 1 | character | character | character | N/A |
| | size: large | size: large | size: large | (no setting |
| | | | | item) |
| level 2 | character | character | character | N/A |
| | size: large | size: large | size: large | (no setting |
| | operation | operation | contrast | item) |
| | feedback | feedback | enhancement: | |
| | sound: On | sound: On | On | |
| | | zoom | | |
| | | function: On | | |

TABLE 2
Accessibility correspondence information regarding hearing

| disability | terminal device | | | |
|---|---|---|---|---|
| severity | television | | video | |
| level | set | smartphone | camera | microwave |
| level 0 | none | none | none | none |
| level 1 | speech | sound | sound | sound |
| | enhancement: On | volume | volume | volume |
| | sound | setting | setting | setting |
| | volume | value: 20 | value: 10 | value: 2 |
| | setting | | | |
| | value: 20 | | | |
| level 2 | speech | LED flash | sound | sound |
| | enhancement: On | notification: On | volume | volume |
| | subtitle: On | sound | setting | setting |
| | sound | volume | value: 20 | value: 3 |
| | volume | setting | | |
| | setting | value: 40 | | |
| | value: 30 | | | |

Accessibility Correspondence Information Storage Unit 15

The accessibility correspondence information storage unit 15 has a function of storing the accessibility correspondence information output from the accessibility correspondence information generation unit 14. The accessibility correspondence information storage unit 15 outputs the stored accessibility correspondence information to the setting information generation unit 16.

Setting Information Generation Unit 16 The setting information generation unit 16 generates the second setting information of the second terminal device 20 used by the user based on the first setting information of the first terminal device 20 acquired when the user uses the first terminal device 20. The setting information generation unit 16 outputs the generated second setting information to the second terminal device 20 and causes the second terminal device 20 to make settings based on the second setting information. As a result, the second terminal device 20 can realize similar accessibility to the first terminal device 20. The setting information generation unit 16 identifies a user based on the environment information and generates second setting information for each user.

Specifically, the setting information generation unit 16 generates the second setting information based on the disability severity information estimated based on the first setting information. This can assist ability lowered due to the disability in the second terminal device 20, as in the first terminal device 20. Further, the setting information generation unit 16 may generate the second setting information based on the first environment information acquired when the user uses the first terminal device 20. Specifically, the setting information generation unit 16 may generate the second setting information based on the disability severity information estimated based on the first environment information. As a result, the second setting information can be generated based on the accurate disability severity information excluding influence of the environment. Further, the setting information generation unit 16 may generate the second setting information based on the characteristic information of the first terminal device 20 and the second terminal device 20. As a result, it is possible to generate appropriate second setting information corresponding to a difference in characteristics between the terminal devices 20.

Specifically, the setting information generation unit 16 generates the second setting information based on the accessibility correspondence information and the disability severity information of the second terminal device 20. As an example, in a case where a visual disability severity level regarding the television set is 2, the setting information generation unit 16 generates second setting information regarding vision designating “character size: large” and “operation feedback sound: ON” by referring to Table 1. As another example, in a case where a hearing disability severity level regarding a smartphone is 1, the setting information generation unit 16 generates second setting information regarding hearing designating “sound volume setting value: 20” by referring to Table 2.

Further, the setting information generation unit 16 may generate the second setting information based on second environment information indicating an environment in which the user uses the second terminal device 20. For example, in a case where a sound volume of environment sound during user's use of the second terminal device 20 is larger than a predetermined threshold value, the setting information generation unit 16 generates second setting information of a higher assisting effect than second setting information generated without consideration of the second environment information. As an example, it is assumed that the hearing disability severity level regarding the smartphone is 1 and the sound volume of the environment sound is higher than the threshold value. In this case, the setting information generation unit 16 generates second setting information regarding hearing designating “sound volume setting value: 30”, which has a higher assisting effect than “sound volume setting value: 20” of the corresponding cell in Table 2. This makes it possible to realize appropriate accessibility taking influence of the environment into consideration.

The first setting information, the second setting information, and a relationship between the first setting information and the second setting information will be described in more detail below.

The first setting information includes setting information related to a first setting item. That is, the first setting information includes a setting value of the first setting item. The first setting item may include one or more setting items. The second setting information includes setting information related to the first setting item and setting information related to a second setting item different from the first setting item. That is, the second setting information includes a setting value of the first setting item and a setting value of the second setting item. The second setting item may include one or more setting items. For example, in a case where the user sets a character size in the first terminal device 20, not only the character size but also a contrast ratio are set in the second terminal device 20. In this way, when the user only sets the first setting item, not only the first setting item but also the second setting item are automatically set. This can lessen user's setting burden.

The first setting item and the second setting item may be setting items regarding ability of the same organ. For example, both the first setting item and the second setting item may be setting items regarding vision. Specifically, in a case where the user sets a character size in the first terminal device 20, a contrast ratio may be set in the second terminal device 20. In this way, even in a case where the user sets only one or some of a plurality of setting items regarding vision, other setting items regarding vision are automatically set. This can lessen user's setting burden.

As another example, the first setting item and the second setting item may be setting items regarding ability of different organs. For example, the first setting item may be a setting item regarding vision, while the second setting item may be a setting item regarding hearing. Specifically, in a case where the user sets a character size in the first terminal device 20, a sound volume may be set in the second terminal device 20. In this case, even in a case where the user makes only settings regarding vision, settings regarding hearing are automatically made. This can lessen user's setting burden. It should be noted that such setting regarding ability of different organs can be realized by estimation of the disability severity information of the different organs described above with reference to FIG. 3.

The first terminal device 20 and the second terminal device 20 may be the same. That is, the terminal device 20 that outputs the first setting information and the terminal device 20 in which the second setting information is input may be the same. For example, in a case where the user sets the first setting item for a certain terminal device 20, setting of the first setting item of the terminal device 20 is updated as necessary, and setting of the second setting item is also made. This can lessen user's setting burden.

The first terminal device 20 and the second terminal device 20 may be different. That is, the terminal device 20 that outputs the first setting information and the terminal device 20 in which the second setting information is input may be different. For example, in a case where the user sets the first setting item for a certain terminal device 20, the first setting item and the second setting item of another terminal device 20 are set. In this case, even in a case where the user makes settings only for a certain terminal device 20, settings of the other terminal device 20 are automatically made. This makes it possible to set each terminal device 20 individually, thereby lessening user's setting burden.

In a case where the first terminal device 20 and the second terminal device 20 are different, it is desirable that the frequency of user's use of the first terminal device 20 is higher than the frequency of user's use of the second terminal device 20. In this case, more accurate disability severity information can be estimated even for the terminal device 20 whose frequency of use is low by taking into consideration a time-series change of the disability severity information, as described above with reference to FIG. 3. As a result, settings of the second terminal device 20 whose frequency of use is low are automatically updated according to the progress of disability. This makes it unnecessary to change settings every time the terminal device 20 whose frequency of use is low is used, thereby lessening user's setting burden. For example, in the example illustrated in FIG. 3, when the user uses the video camera for the first time in a long time at the time t₁, second setting information corresponding to not the disability severity level 0 estimated at the time t₀ but the disability severity level 1 estimated at the time t₁ can be generated. The terminal device 20 whose frequency of use is high can be regarded as the terminal device 20 before replacement or software version upgrade, and the terminal device 20 whose frequency of use is low can be regarded as the terminal device 20 after replacement or software version upgrade. In this case, after replacement or software version upgrade of the terminal device 20, it is unnecessary to enter settings similar to those before the replacement or software version upgrade again. This can lessen user's setting burden.

<<2. Flow of Processing>>

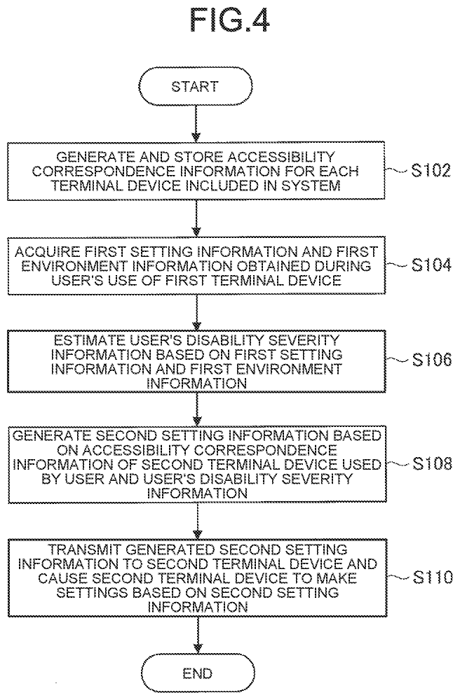

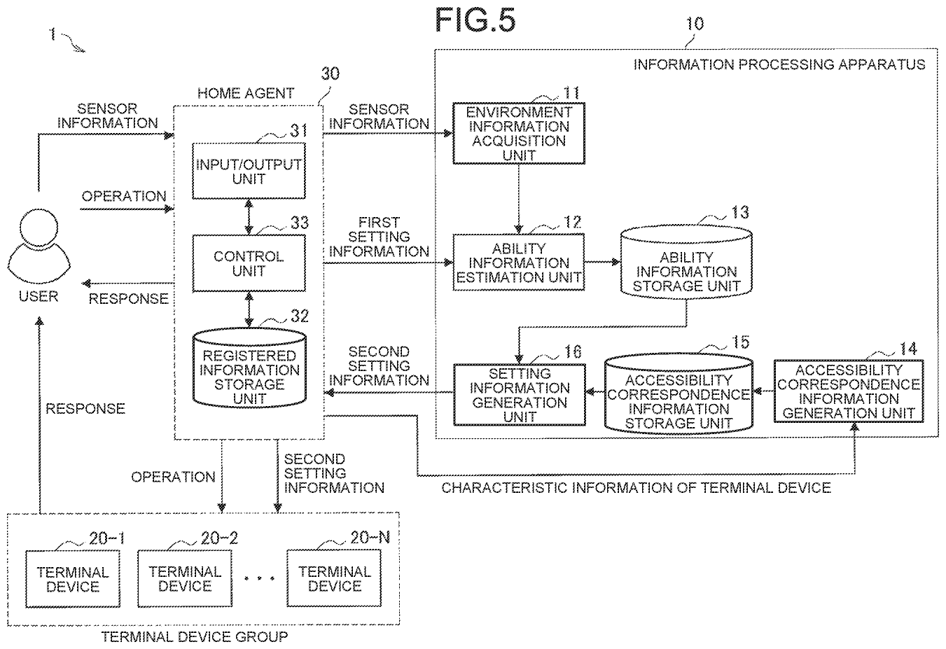

An example of a flow of processing will be described below with reference to FIG. 4. FIG. 4 is a flowchart illustrating an example of a flow of accessibility setting processing executed by the information processing apparatus 10 according to the present embodiment.

As illustrated in FIG. 4, first, the information processing apparatus 10 generates and stores accessibility correspondence information of each terminal device 20 included in the system 1 (step S102). In this step, the information processing apparatus 10 generates accessibility correspondence information of each terminal device 20 based on the characteristic information of the terminal device 20. Next, the information processing apparatus 10 acquires the first setting information and the first environment information acquired when the user uses the first terminal device 20 (step S104). Next, the information processing apparatus 10 estimates user's disability severity information based on the first setting information and the first environment information (step S106). In this step, the information processing apparatus 10 may estimate the disability severity information further based on the characteristic information of the first terminal device 20. Next, the information processing apparatus 10 generates the second setting information based on the accessibility correspondence information of the second terminal device 20 used by the user and the disability severity information of the user (step S108). In this step, the information processing apparatus 10 may generate the second setting information further based on the second environment information indicating an environment in which the user uses the second terminal device 20. Then, the information processing apparatus 10 transmits the generated second setting information to the second terminal device 20, and causes the second terminal device 20 to make settings based on the second setting information (step S110).

<<3. Use Case>>

(1) Use Case Related to Visual Impairment

As an example, a use case in which a visually impaired user who uses a smartphone every day but finds it difficult to see a screen more and more every day uses a video camera for the first time in several months will be described. In this use case, the first terminal device 20 is the smartphone and the second terminal device 20 is the video camera.

First, the information processing apparatus 10 registers the smartphone and the video camera as the terminal devices 20 used by the user. Next, the information processing apparatus 10 acquires characteristic information of the smartphone and the video camera, and generates and stores accessibility correspondence information of the smartphone and the video camera according to the characteristic information.

When using the smartphone, the user finds it difficult to see the screen and sets a character size to the maximum. Then, the information processing apparatus 10 estimates and updates user's disability severity level regarding vision from the change in setting value of the character size. Thereafter, the user further feels that the screen is difficult to see when using the smartphone and sets an operation feedback sound function to ON and a character zoom function to ON. The information processing apparatus 10 tracks such daily updates of setting information and estimates and updates the disability severity level regarding vision.

When the user uses the video camera for the first time in several months, the information processing apparatus 10 generates setting information for the video camera according to a current disability severity level regarding vision based on the disability severity level regarding vision estimated based on the situation during use of the smartphone and the accessibility correspondence information of the video camera and sets the setting information in the video camera. In this case, the user can use the video camera for which settings according to the current disability severity level have been made without making settings of the video camera in advance.

(2) Use Case Related to Hearing Impairment

As another example, a use case in which a hearing-impaired user who watches TV every day but finds it difficult to hear sound more and more every day uses a video camera for the first time in several months will be described. In this use case, the first terminal device 20 is a television set and the second terminal device 20 is the video camera.

First, the information processing apparatus 10 registers the television set and the video camera as the terminal devices 20 used by the user. Next, the information processing apparatus 10 acquires characteristic information of the television set and the video camera and generates and stores the accessibility correspondence information of the television set and the video camera according to the characteristic information.

The user finds it difficult to hear news sound when watching TV and sets a sound volume level higher than before and sets a speech enhancement function to ON. Then, the information processing apparatus 10 estimates and updates a user's disability severity level regarding hearing from these changes in setting values.

After that, the user sets the sound volume level even higher because a construction is going on around a user's house during watching of TV. The information processing apparatus 10 recognizes that a noise level is high during watching of TV by collecting environment sounds around the user and acquires such information as environment information. Then, the information processing apparatus 10 estimates that the increase in sound volume level is not due to the progress of the user's disability but due to the deterioration of the noise level based on the change in sound volume level and the environment information and does not change the disability severity level regarding hearing.

When the user uses the video camera for the first time in several months, the information processing apparatus 10 generates setting information for the video camera according to a current disability severity level regarding hearing based on the disability severity level regarding hearing estimated based on the situation during watching of TV and the accessibility correspondence information of the video camera and sets the setting information in the video camera. In this case, the user can use the video camera for which settings according to the current disability severity level have been made without making settings of the video camera in advance.

<<4. Modifications>>

<4.1. First Modification>

Although the terminal device 20 which is hardware has been described as an example of the object, the present technique is not limited to such an example. The object may be software such as an application. Examples of the application include any applications that output information such as a video viewing application, an image viewing application, and a game application.

Even in a case where the object is an application, a similar technique to that in the above embodiment can be applied. That is, the information processing apparatus 10 generates the second setting information of a second application used by the user based on the first setting information of a first application acquired when the user uses the first application.

<4.2. Second Modification>

The present modification is an example in which the system 1 includes a home agent. The present modification will be described below with reference to FIG. 5.

FIG. 5 is a block diagram illustrating an example of a configuration of the system 1 according to the present modification. As illustrated in FIG. 5, the system 1 according to the present modification includes a home agent 30 in addition to the configuration illustrated in FIG. 1. The home agent 30 is a device that outputs a response in response to a user's operation. For example, the home agent 30 plays music or reads out a weather forecast in response to a voice instruction from the user. The home agent 30 according to the present modification has a function of relaying exchange of information between any two of the user, the information processing apparatus 10, and the terminal devices 20.

(1) Configuration of Home Agent 30

The configuration of the home agent 30 will be described below. As illustrated in FIG. 5, the home agent 30 includes an input/output unit 31, a registered information storage unit 32, and a control unit 33.

Input/Output Unit 31

The input/output unit 31 has a function as an input unit that receives information from an outside and a function as an output unit that outputs information to the outside. The function as an input unit can be realized by various sensor devices such as an image sensor, a sound sensor, an illuminance sensor, and a touch sensor. The function as an output unit can be realized by various output devices such as a display device, an audio output device, and a vibration device.

The input/output unit 31 includes a communication device capable of transmitting/receiving information to/from another device. For example, the communication device may perform communication with the information processing apparatus 10 and the terminal devices 20 according to any wired or wireless communication standard. Examples of such a communication standard include a local area network (LAN), a wireless LAN, Wi-Fi, and Bluetooth.

Registered Information Storage Unit 32

The registered information storage unit 32 has a function of storing registered information regarding the terminal devices 20. For example, the registered information storage unit 32 stores therein characteristic information of each terminal device 20.

Control Unit 33 The control unit 33 functions as an arithmetic processing device and a control device and controls overall operation in the home agent 30 according to various programs.

The control unit 33 has a function of relaying exchange of information between the user and the information processing apparatus 10. Specifically, the control unit 33 transmits sensor information acquired by the input/output unit 31 to the information processing apparatus 10. In this case, the information processing apparatus 10 need not include a sensor device.

The control unit 33 has a function of relaying exchange of information between the user and the terminal device 20. Specifically, when the user performs an operation for the terminal device 20, the control unit 33 relays information indicating the operation to the terminal device 20. For example, when the user performs a voice operation for the terminal device 20, the control unit 33 performs voice recognition and transmits a result of the voice recognition to the terminal device 20. Then, the terminal device 20 outputs a response according to the operation from the user. Further, when accessibility settings of the terminal device 20 are made by the user, the control unit 33 extracts the first setting information from the operation history and transmits the first setting information to the information processing apparatus 10.

The control unit 33 has a function of relaying exchange of information between the information processing apparatus 10 and the terminal device 20. Specifically, the control unit 33 acquires characteristic information of the terminal device 20 in advance, stores the characteristic information in the registered information storage unit 32, and transmits the characteristic information stored in the registered information storage unit 32 to the information processing apparatus 10 as needed. Further, the control unit 33 relays the second setting information generated by the information processing apparatus 10 to the second terminal device 20.

The control unit 33 has a function of exchanging information with the user. Specifically, the control unit 33 outputs a response when operated by the user. For example, the control unit 33 performs processing according to a voice operation from the user.

(2) Configuration and Operation of Information Processing Apparatus 10

The configuration and operation of the information processing apparatus 10 are similar to those in the above embodiment. However, since sensor information is provided by the home agent 30, the environment information acquisition unit 11 need not have a sensor device. The ability information estimation unit 12 acquires the first setting information from the home agent 30. The accessibility correspondence information generation unit 14 acquires characteristic information of the terminal device 20 from the home agent 30. The setting information generation unit 16 transmits the generated second setting information to the terminal device 20 via the home agent 30.

(3) Effect

According to the present modification, the user can operate the terminal device 20 via the home agent 30. Further, the user can enjoy automatic update of accessibility settings of the second terminal device 20 by making accessibility settings of the first terminal device 20 via the home agent 30.

<4.3. Third Modification>

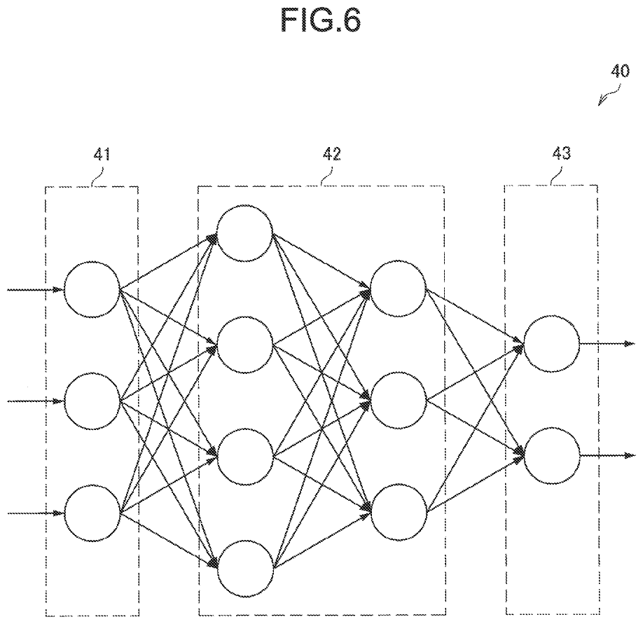

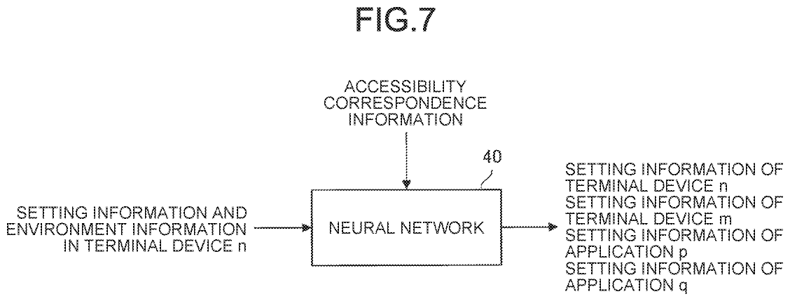

The present modification is an example in which a neural network is used. First, an outline of the neural network will be described with reference to FIG. 6, and then an application example of the neural network to the present technique will be described with reference to FIG. 7.

FIG. 6 is a diagram for explaining an outline of the neural network. As illustrated in FIG. 6, the neural network 40 is made up of three types of layers, an input layer 41, an intermediate layer 42, and an output layer 43, and has a network structure in which nodes included in the layers are connected by links. The circles in FIG. 6 correspond to the nodes, and the arrows in FIG. 6 correspond to the links. When input data is input to the input layer 41, computation at the nodes and weighting at the links are performed in the order from the input layer 41 to the intermediate layer 42 and from the intermediate layer 42 to the output layer 43, and output data is output from the output layer 43. Among neural networks, those having a predetermined number of layers or more are also referred to as deep learning.

A neural network is known to be able to approximate any function. A neural network can learn a network structure that matches teacher data by using a calculation method such as backpropagation. Therefore, by constructing a model by using a neural network, the model is released from restriction of expression capability that the model is designed within a range that can be understood by humans.

FIG. 7 is a diagram for explaining an application example of the neural network in the information processing apparatus 10 according to the present modification. The neural network 40 illustrated in FIG. 7 has a function of the ability information estimation unit 12 and the setting information generation unit 16 illustrated in FIG. 1. That is, the neural network 40 receives the first setting information, the first environment information, and the accessibility correspondence information and outputs the second setting information. In the example illustrated in FIG. 7, the neural network 40 receives setting information and environment information acquired when the user uses a terminal device n corresponding to a first object and accessibility correspondence information of each object and outputs setting information of a second object. For example, the neural network 40 generates setting information of the terminal device n, generates setting information of a terminal device m (n≠m), generates setting information of an application p, and generates setting information of an application q.

<4.4. Fourth Modification>

Although an example in which the second setting information includes a setting value of the first setting item and a setting value of the second setting item different from the first setting item has been described above, the present technique is not limited to such an example.

For example, the second setting information may include only the setting value of the first setting item. In this case, setting of the first setting item made by the user can be automatically reflected not only in the first terminal device 20 but also in the second terminal device 20. This can lessen user's setting burden.

As another example, the second setting information may include only the setting value of the second setting item. In this case, even in a case where the user sets only the first setting item, setting of the second setting item is automatically made. This can lessen user's setting burden.

<<5. Example of Hardware Configuration>>

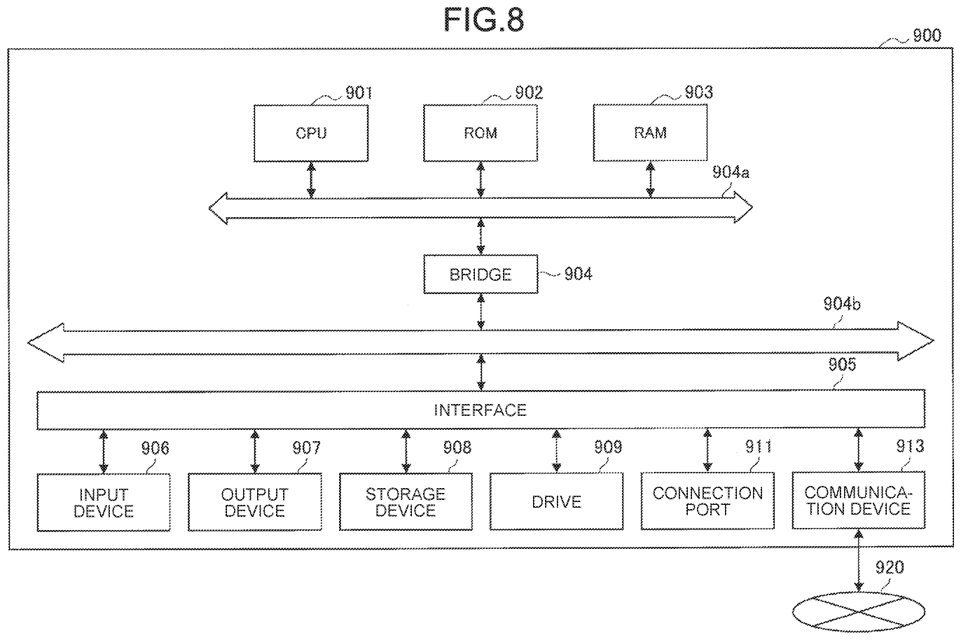

Finally, a hardware configuration of an information processing apparatus according to the present embodiment will be described with reference to FIG. 8. FIG. 8 is a block diagram illustrating an example of the hardware configuration of the information processing apparatus according to the present embodiment. An information processing apparatus 900 illustrated in FIG. 8 can realize, for example, the information processing apparatus 10, the terminal devices 20, or the home agent 30 illustrated in FIGS. 1 and 5. Information processing performed by the information processing apparatus 10, the terminal devices 20, or the home agent 30 according to the present embodiment is realized by cooperation between software and hardware described below.

As illustrated in FIG. 8, the information processing apparatus 900 includes a central processing unit (CPU) 901, a read only memory (ROM) 902, a random access memory (RAM) 903, and a host bus 904a. Further, the information processing apparatus 900 includes a bridge 904, an external bus 904b, an interface 905, an input device 906, an output device 907, a storage device 908, a drive 909, a connection port 911, and a communication device 913. The information processing apparatus 900 may have a processing circuit such as an electric circuit, a DSP, or an ASIC in place of or in combination with the CPU 901.

The CPU 901 functions as an arithmetic processing device and a control device, and controls overall operation in the information processing apparatus 900 according to various programs. The CPU 901 may be a microprocessor. The ROM 902 stores therein programs, calculation parameters, and the like used by the CPU 901. The RAM 903 temporarily stores therein a program used in execution by the CPU 901, parameters that change appropriately in the execution, and the like. The CPU 901 is an example of a control unit that controls the information processing apparatus 900. Alternatively, the control unit may be a DSP or any other electrical circuit. The CPU 901 can form, for example, the environment information acquisition unit 11, the ability information estimation unit 12, the accessibility correspondence information generation unit 14, and the setting information generation unit 16 illustrated in FIG. 1 and the control unit 33 illustrated in FIG. 5.

The CPU 901, ROM 902 and RAM 903 are connected to each other by the host bus 904a such as a CPU bus. The host bus 904a is connected to the external bus 904b such as a peripheral component interconnect/interface (PCI) bus via the bridge 904. It should be noted that the host bus 904a, the bridge 904, and the external bus 904b need not be separate from one another, and these functions may be implemented on one bus.

The input device 906 is realized by a device to which information is input by a user, such as a mouse, a keyboard, a touch panel, a button, a microphone, a switch, and a lever. The input device 906 may be, for example, a remote control device using infrared rays or other radio waves or may be an externally connected device such as a mobile phone or a PDA that supports operations of the information processing apparatus 900. Further, the input device 906 may include, for example, an input control circuit that generates an input signal based on the information input by the user by using the above input means and outputs the input signal to the CPU 901. By operating the input device 906, the user of the information processing apparatus 900 can input various data to the information processing apparatus 900 and give an instruction to perform processing operation.

Alternatively, the input device 906 may be formed by a device that detects information about the user. For example, the input device 906 may include various sensors such as an image sensor (for example, a camera), a depth sensor (for example, a stereo camera), an acceleration sensor, a gyro sensor, a geomagnetic sensor, an optical sensor, a sound sensor, a distance measuring sensor, and a force sensor. Further, the input device 906 may acquire information on a state of the information processing apparatus 900 itself such as a posture and a moving speed of the information processing apparatus 900 and information on a surrounding environment of the information processing apparatus 900 such as brightness and noise around the information processing apparatus 900. In addition, the input device 906 may include a global navigation satellite system (GNSS) module that receives a GNSS signal from a GNSS satellite (for example, a GPS signal from a global positioning system (GPS) satellite) and measures position information including latitude, longitude and altitude of the device. As for the position information, the input device 906 may detect the position, for example, by Wi-Fi (registered trademark), transmission/reception to and from a mobile phone, a PHS, a smartphone, or the like, or short-range communication. The input device 906 can form, for example, the environment information acquisition unit 11 illustrated in FIG. 1 and the input/output unit 31 illustrated in FIG. 5.

The output device 907 is formed by a device capable of visually or audibly notifying the user of acquired information. Examples of such a device include display devices such as CRT display devices, liquid crystal display devices, plasma display devices, EL display devices, laser projectors, LED projectors and lamps, audio output devices such as speakers and headphones, and printer devices. The output device 907 outputs, for example, results obtained by various kinds of processing performed by the information processing apparatus 900. Specifically, the display device visually displays results obtained by various kinds of processing performed by the information processing apparatus 900 in various formats such as texts, images, tables, and graphs. The audio output device converts an audio signal composed of reproduced audio data, acoustic data, or the like into an analog signal and outputs the analog signal audibly. The output device 907 can form, for example, the input/output unit 31 illustrated in FIG. 5.

The storage device 908 is a data storage device formed as an example of a storage unit of the information processing apparatus 900. The storage device 908 is realized by, for example, a magnetic storage device such as an HDD, a semiconductor storage device, an optical storage device, an optical magnetic storage device, or the like. The storage device 908 may include a storage medium, a recording device that records data on the storage medium, a reading device that reads data from the storage medium, a deleting device that deletes the data recorded on the storage medium, and the like. The storage device 908 stores programs and various data executed by the CPU 901, various data acquired from the outside, and the like. The storage device 908 may form, for example, the ability information storage unit 13 and the accessibility correspondence information storage unit 15 illustrated in FIG. 1 and the registered information storage unit 32 illustrated in FIG. 5.

The drive 909 is a reader/writer for a storage medium, and is built in or externally attached to the information processing apparatus 900. The drive 909 reads out information recorded on a removable storage medium such as a mounted magnetic disk, optical disk, magneto-optical disk, or semiconductor memory, and outputs the information to the RAM 903. The drive 909 can also write information to the removable storage medium.

The connection port 911 is an interface for connecting to an external device, and is a connection port with an external device that is capable of transmitting data by, for example, USB (Universal Serial Bus).

The communication device 913 is, for example, a communication interface formed by a communication device or the like for connecting to the network 920. The communication device 913 is, for example, a wired or wireless local area network (LAN), long term evolution (LTE), Bluetooth (registered trademark), wireless USB (WUSB), or a communication card for infrared communication. The communication device 913 may be a router for optical communication, a router for asymmetric digital subscriber line (ADSL), a modem for various communications, or the like. The communication device 913 can transmit and receive signals and the like to and from the Internet and other communication devices in accordance with a predetermined protocol such as TCP/IP. The communication device 913 can form, for example, the ability information estimation unit 12, the accessibility correspondence information generation unit 14, and the setting information generation unit 16 illustrated in FIG. 1 and the input/output unit 31 illustrated in FIG. 5. The communication device 913 performs, for example, communication among the information processing apparatus 10, the terminal devices 20, and the home agent 30.

The network 920 is a wired or wireless transmission path for information transmitted from a device connected to the network 920. Examples of the network 920 may include a public network such as the Internet, a telephone network, and a satellite communication network, various local area networks (LANs) including Ethernet (registered trademark), and a wide area network (WAN). Further, examples of the network 920 may include a dedicated network such as internet protocol-virtual private network (IP-VPN).

An example of a hardware configuration capable of realizing the functions of the information processing apparatus 900 according to the present embodiment has been described above. Each of the above constituent elements may be realized by using a general-purpose member or may be realized by hardware specialized for a function of the constituent element. Therefore, it is possible to appropriately change the hardware configuration to be used according to a technical level at each time when the present embodiment is implemented.

It is possible to create a computer program for realizing each function of the information processing apparatus 900 according to the present embodiment as described above and implement the program on a PC or the like. It is also possible to provide a computer-readable recording medium in which such a computer program is stored. The recording medium is, for example, a magnetic disk, an optical disk, a magneto-optical disk, a flash memory, or the like. Further, the computer program may be distributed, for example, over a network without using a recording medium.

<<6. Summary>>

One embodiment of the present disclosure has been described in detail above with reference to FIGS. 1 to 8. As described above, the information processing apparatus 10 according to the present embodiment generates second setting information related to a first setting item and a second setting item different from the first setting item of a second object used by a user based on first setting information related to the first setting item of a first object acquired when the user uses the first object. The user only needs to set the first setting item of the first object, and settings of the first setting item and the second setting item of the second object are automatically made. Considering that accessibility setting items can be diverse, it is possible to reduce user's setting burden because the number of setting items that need user's entry is reduced.

Further, as described above, the setting information is set according to user's ability in order to assist the user's ability deteriorated due to a disability, injury, illness, or the like. Typically, persons with disabilities tend to prefer to act on their own without the help of others. In this respect, according to the present technique, it is possible to lessen setting burden of a person with a disability who needs to make accessibility settings. This can support the person with a disability to use an object by himself/herself. This makes it possible to improve the quality of life (QOL) of persons with disabilities.

Although the preferred embodiment of the present disclosure has been described in detail above with reference to the accompanying drawings, the technical scope of the present disclosure is not limited to such an example. It is clear that a person skilled in the art of the present disclosure may come up with various changes or modifications within the scope of the technical ideas set forth in the claims, and it is understood that such changes or modifications also belong to the technical scope of the present disclosure.

Each device described in this specification may be realized as a single device or a part or all of each device may be realized as separate devices. For example, some (for example, the accessibility correspondence information generation unit 14 and the accessibility correspondence information storage unit 15) of the constituent elements of the information processing apparatus 10 illustrated in FIG. 1 may be provided in a device such as a server on cloud connected to the other constituent elements (for example, the environment information acquisition unit 11, the ability information estimation unit 12, the ability information storage unit 13, and the setting information generation unit 16) over a network or the like. A combination of constituent elements mapped to the information processing apparatus 10 and the server is not limited to the one described above.

Further, the processes described with reference to the flowchart and the sequence diagram in the present specification need not necessarily be executed in the illustrated order. Some processing steps may be performed in parallel. Further, an additional processing step may be adopted, and one or more processing steps may be omitted.

The effects described herein are merely explanatory or illustrative and are not restrictive. That is, the technique according to the present disclosure may exhibit other effects apparent to those skilled in the art from the description herein, in addition to or in place of the above effects.

The following configurations also belong to the technical scope of the present disclosure.

(1)

An information processing apparatus comprising

a control unit that generate second setting information related to a first setting item and a second setting item different from the first setting item of a second object used by the user based on first setting information related to the first setting item of a first object acquired when the user uses the first object.

(2)

The information processing apparatus according to (1), wherein

the first setting information is related to accessibility to output of the first object; and

the second setting information is related to accessibility to output of the second object.

(3)

The information processing apparatus according to (1) or (2), wherein the first setting item and the second setting item are setting items regarding ability of a same organ.

(4)

The information processing apparatus according to (1) or (2), wherein the first setting item and the second setting item are setting items regarding ability of different organs.

(5)

The information processing apparatus according to any one of (1) to (4), wherein the first object and the second object are the same.

(6)

The information processing apparatus according to any one of (1) to (4), wherein the first object and the second object are different from each other.

(7)

The information processing apparatus according to (6), wherein frequency of user's use of the first object is higher than frequency of user's use of the second object.

(8)

The information processing apparatus according to any one of (1) to (7), wherein the control unit generates the second setting information further based on characteristic information indicating characteristics concerning accessibility of the first object and the second object.

(9)

The information processing apparatus according to any one of (1) to (8), wherein the control unit generates the second setting information based on first environment information indicating an environment in which the user uses the first object.

(10)

The information processing apparatus according to any one of (1) to (9), wherein the control unit generates the second setting information based on second environment information indicating an environment in which the user uses the second object.

(11)

The information processing apparatus according to any one of (1) to (10), wherein the control unit estimates ability information indicating ability of the user based on the first setting information and generates the second setting information based on the estimated ability information.

(12)

The information processing apparatus according to any one of (1) to (11), wherein the first object and the second object are terminal devices.

(13)

The information processing apparatus according to any one of (1) to (11), wherein the first object and the second object are applications.

(14)

The information processing apparatus according to any one of (1) to (13), wherein the second setting information includes setting information related to at least one of character size, zoom, contrast, character reading, and operation feedback sound as setting information regarding vision.

(15)

The information processing apparatus according to any one of (1) to (14), wherein the second setting information includes setting information related to at least one of sound volume, speech enhancement, visual notification, and subtitles as setting information regarding hearing.

(16)

An information processing method comprising causing a processor to generate second setting information related to a first setting item and a second setting item different from the first setting item of a second object used by the user based on first setting information related to the first setting item of a first object acquired when the user uses the first object.

### REFERENCE SIGNS LIST

1 SYSTEM
10 INFORMATION PROCESSING APPARATUS
11 ENVIRONMENT INFORMATION ACQUISITION UNIT
12 ABILITY INFORMATION ESTIMATION UNIT
13 ABILITY INFORMATION STORAGE UNIT
14 ACCESSIBILITY CORRESPONDENCE INFORMATION GENERATION UNIT
15 ACCESSIBILITY CORRESPONDENCE INFORMATION STORAGE UNIT
16 SETTING INFORMATION GENERATION UNIT
20 TERMINAL DEVICE
30 HOME AGENT
31 INPUT/OUTPUT UNIT
32 REGISTERED INFORMATION STORAGE UNIT
33 CONTROL UNIT
40 NEURAL NETWORK
41 INPUT LAYER
42 INTERMEDIATE LAYER
43 OUTPUT LAYER

1. An information processing apparatus comprising
a control unit that generate second setting information related to a first setting item and a second setting item different from the first setting item of a second object used by the user based on first setting information related to the first setting item of a first object acquired when the user uses the first object.

2. The information processing apparatus according to claim 1, wherein
the first setting information is related to accessibility to output of the first object; and
the second setting information is related to accessibility to output of the second object.

3. The information processing apparatus according to claim 1, wherein the first setting item and the second setting item are setting items regarding ability of a same organ.

4. The information processing apparatus according to claim 1, wherein the first setting item and the second setting item are setting items regarding ability of different organs.

5. The information processing apparatus according to claim 1, wherein the first object and the second object are the same.

6. The information processing apparatus according to claim 1, wherein the first object and the second object are different from each other.

7. The information processing apparatus according to claim 6, wherein frequency of user's use of the first object is higher than frequency of user's use of the second object.

8. The information processing apparatus according to claim 1, wherein the control unit generates the second setting information further based on characteristic information indicating characteristics concerning accessibility of the first object and the second object.

9. The information processing apparatus according to claim 1, wherein the control unit generates the second setting information based on first environment information indicating an environment in which the user uses the first object.

10. The information processing apparatus according to claim 1, wherein the control unit generates the second setting information based on second environment information indicating an environment in which the user uses the second object.

11. The information processing apparatus according to claim 1, wherein the control unit estimates ability information indicating ability of the user based on the first setting information and generates the second setting information based on the estimated ability information.

12. The information processing apparatus according to claim 1, wherein the first object and the second object are terminal devices.

13. The information processing apparatus according to claim 1, wherein the first object and the second object are applications.

14. The information processing apparatus according to claim 1, wherein the second setting information includes setting information related to at least one of character size, zoom, contrast, character reading, and operation feedback sound as setting information regarding vision.

15. The information processing apparatus according to claim 1, wherein the second setting information includes setting information related to at least one of sound volume, speech enhancement, visual notification, and subtitles as setting information regarding hearing.

16. An information processing method comprising causing a processor to generate second setting information related to a first setting item and a second setting item different from the first setting item of a second object used by the user based on first setting information related to the first setting item of a first object acquired when the user uses the first object.
